(19) United States
(12) Patent Application Publication
(10) Pub. No.: US 2026/0309569 A1
(43) Pub. Date: Oct. 8, 2026

(54) ELECTRO-MAGNETIC ACOUSTIC TRANSDUCER (EMAT) WITH TRI-AXIAL TRANSVERSE FIELD INSPECTION (TFI)

(71) Applicant: PIPECARE US, LLC, Houston, TX (US)

(72) Inventor: Muhamed-Khaled El-Chami, Dubai (AE)

(21) Appl. No.: 19/638,873

(22) Filed: Apr. 3, 2026

Related U.S. Application Data
(60) Provisional application No. 63/782,937, filed on Apr. 3, 2025.

(51) Int. Cl. G01M 3/00

(52) U.S. Cl. CPC G01M 3/005

(57) ABSTRACT

A pipeline inspection method and system using simultaneous or virtually simultaneous electromagnetic acoustic transducer (EMAT) and transverse field inspection (TFI) measurement modes is disclosed herein. The pipeline inspection method and system are configured to perform an EMAT measurement process and a TFL measurement process in a single traversal of a pipeline and to identify pipeline features of interest for a pipeline inspection. A shared magnetizer provides a static magnetic field for both the EMAT measurement process and the TFI measurement process. Individual EMAT and TFI samples are sequenced in time, with an individual sample of either mode being executed in a duration on an order of milliseconds or tens of milliseconds. EMAT and TFI measurement sensors are placed in an angularly-staggered and axially-staggered fashion on a pipeline inspection gauge (PIG) to achieve full coverage of an interior surface of a pipeline wall.

### PRIORITY CLAIM

This application claims priority to and the benefit as a non-provisional application of U.S. Provisional Patent Application No. 63/782,937, filed on Apr. 3, 2025, the entire contents of which are hereby incorporated by reference and relied upon.

### BACKGROUND

Oil and gas pipelines are prevalent throughout the developed world. These pipelines may degrade over time, developing defects or fractures that may prevent resource transport or pose environmental risks. Various systems and methods exist for automated pipeline inspection, including in-line inspection devices or pipeline inspection gauges (PIGs) that traverse a pipeline internally, even while oil, gas, or another resource flows through the pipeline. Such PIGs may rely on various methods to interrogate a surface or a volume of a pipeline wall, including measurement of reflected acoustic or electromagnetic waves, or measurement of electromagnetic field deformation by defects or irregularities in a pipeline wall.

To minimize the risk of failure or a leak, pipelines are diligently monitored and inspected. One of the primary inspection methods utilized by the pipeline industry is in-line inspection. Commonly, an in-line inspection tool, known in the industry as a pipeline inspection gauge (PIG), is inserted and propelled through a pipeline. The PIG includes a number of sensor arms and odometers that contact an inside surface of a pipeline. Typically, a PIG has a number of sensor arms that adequately cover the complete interior circumference of a pipeline. The sensor arms move downward when a pipe deformity extends inward towards an interior of a pipe and move upward when a pipe deformity extends outwards. During an inspection, the PIG moves at a rate between 0.1 meter/second to 5 meters/second and records how much each sensor arm moves up and down along an interior surface of the pipeline. Data from the sensor arms are stored in a raw data file that relates sensor arm movement to distance traveled, as measured by the odometer.

Some known in-line PIGs use magnetic fields or acoustics to detect anomalies including cracks and other flaws. For instance, some known PIGs induce magnetic fields in the pipeline wall using transverse field inspection (TFI). Sensors in these known devices use the magnetic fields to detect magnetic flux leakage (MFL), which is indicative of flaws and a degradation in ferro-magnetic materials of the pipeline. Other known devices use electro-magnetic acoustic transducers (EMAT) to provide ultrasonic testing. The ultrasonic transducers generate sound waves within a pipeline using electromagnetic forces to detect pipeline flaws. The known in-line inspection devices were limited to using either TFI or EMAT since the sensor and transducers of each testing modality interfere with each other.

### SUMMARY

Systems and methods for inspecting a pipeline for defects by combining an EMAT measurement process and a TFI measurement process are disclosed herein. Such systems and methods use a common magnetizer for both an EMAT and a TFI measurement process and interleave individual measurement samples for an EMAT and a TFI measurement process. A system for inspecting a pipeline collects an EMAT measurement sample in a first-time duration and collects a TFI measurement sample in a second time duration. The system disclosed herein contains staggered EMAT and TFI sensors such that there is redundancy in a sampling coverage of a pipeline surface. Sequencing EMAT and TFI sampling within a shared sampling window reduces electromagnetic and acoustic interference between sensing modalities while preserving spatial correlation.

In one aspect, a system is provided for inspecting pipelines using a pipeline inspection gauge (PIG) that is configured to perform multiple nondestructive inspection techniques during a single traversal of a pipeline. The PIG includes at least one cylindrical measurement section carrying a magnetizer that applies a static magnetic field to a wall of the pipeline. The static magnetic field is used in cooperation with both an EMAT measurement process and a transverse field inspection TFI measurement process, enabling the system to acquire complementary inspection information without requiring multiple inspection runs.

The PIG further includes one or more measurement surfaces positioned around the cylindrical measurement section, each measurement surface carrying at least one EMAT sensor and at least one TFI sensor. During operation, the EMAT sensor and the TFI sensor interact with the applied static magnetic field to collect EMAT measurement samples and TFI measurement samples, respectively. The system is configured to collect EMAT and TFI measurement samples sequentially and within short time durations, such that both types of measurements may be obtained over substantially the same regions of the pipeline wall as the PIG traverses the pipeline.

A processor disposed on the PIG is communicatively coupled to the EMAT sensors, the TFI sensors, and a memory device. The processor is configured to store EMAT measurement information and TFI measurement information, to collect EMAT measurement samples in sequence with TFI measurement samples, and to collect position information indicative of a location of the PIG along the pipeline. In this manner, the system is operable to inspect a length of the pipeline using both EMAT and TFI measurement processes during a single traversal of the PIG and to associate the collected measurement information with corresponding axial and angular positions along the pipeline.

In some implementations, the system further includes a computer that is separate from the PIG and communicatively coupled to the processor by a wired or wireless connection. The computer is configured to receive EMAT measurement information, TFI measurement information, and position information from the PIG, to combine EMAT measurement samples with TFI measurement samples, and to correlate the combined measurement information with position data. The computer may process the combined data to identify pipeline features, assign a feature class to each identified feature, and determine one or more geometric characteristics of each feature, including axial position, angular position, linear dimensions, and size.

In certain embodiments, the measurement surfaces of the PIG include one or more measurement flaps that support an EMAT transmitter coil, an EMAT receiver coil, and an array of Hall sensors. The Hall sensor array may partially overlap the EMAT receiver coil and may include tri-axial Hall sensors or single-axis Hall sensors arranged with a selected spacing relative to the receiver coil. The EMAT transmitter coil and the EMAT receiver coil may be angularly offset relative to a cylindrical axis of the PIG measurement section, and multiple cylindrical measurement sections may be arranged along a common axis with angularly offset measurement surfaces to provide circumferential coverage of the pipeline wall. Angular offsets between adjacent measurement surfaces are selected to balance circumferential coverage with redundancy, thereby reducing the likelihood of missed defects while limiting sensor overlap.

In further aspects, the system may incorporate additional sensors, such as one or more odometers and one or more angular orientation sensors, to provide enhanced positional accuracy. Data from such sensors may be stored by the processor and combined with the EMAT and TFI measurement information to improve spatial correlation of detected pipeline features. The system may further generate an electronic report identifying detected pipeline features and their associated characteristics, and may transmit the electronic report to a client device for display or further analysis.

In another aspect, a method is provided for inspecting pipelines that includes traversing a pipeline once with a PIG, applying a static magnetic field through a wall of the pipeline with a magnetizer, collecting EMAT measurement samples during the traversal within a first time duration, and collecting TFI measurement samples during the traversal within a second time duration. The method may further include generating EMAT measurement data and TFI measurement data from the collected samples, combining the EMAT and TFI measurement data to create a map of a physical condition of the pipeline wall, and identifying defects or features, including cracks, based on physical anomalies represented in the combined measurement data.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a diagram of an example pipeline inspection system including a PIG measurement section with a measurement surface, according to an example embodiment of the present disclosure.

FIGS. 2A and 2B are cross-sectional diagrams of an example pipeline inspection system including a PIG measurement section and multiple measurement surfaces distributed around a cylindrical axis, according to example embodiments of the present disclosure.

FIG. 2C is an assembly-view diagram of a measurement surface, according to example embodiments of the present disclosure.

FIG. 3 is a diagram of an example pipeline inspection system including multiple PIG measurement sections, each with measurement surfaces staggered at different angles relative to a common cylindrical axis, according to an example embodiment of the present disclosure.

FIGS. 4A & 4B are diagrams of example pipeline inspection systems including multiple PIG measurement sections and multiple instrument sections, according to an example embodiment of the present disclosure.

FIG. 5 is a timing diagram of a sequencing of a TFI sampling and an EMAT sampling of a PIG as it traverses a pipeline, according to an example embodiment of the present disclosure.

FIG. 6 is a plot of sensed data from a pipeline inspection, according to an example embodiment of the present disclosure.

FIG. 7 is a diagram of a system for inspecting pipelines, including a PIG and external data processing system, according to an example embodiment of the present disclosure.

### DETAILED DESCRIPTION

In pipeline inspection systems that employ both electromagnetic acoustic transduction (EMAT) and magnetic field-based inspection techniques, magnetization requirements are typically treated as distinct and incompatible. EMAT operation relies on a static magnetic field of sufficient strength and uniformity to support Lorentz-force generation of ultrasonic waves, while transverse field inspection (TFI) relies on magnetization of the pipeline wall to produce detectable magnetic flux leakage in the presence of material discontinuities. In the disclosed system, a single magnetizer is configured to generate a static magnetic field within a range that simultaneously satisfies the operational requirements of both EMAT and TFI sensing modalities. By selecting a magnetization profile that supports ultrasonic transduction while maintaining sensitivity to transverse leakage fields, the system eliminates the need for separate magnetization subsystems, thereby reducing tool complexity, size, and power consumption while enabling co-located sensing.

Although EMAT and TFI measurements may be described as simultaneous or near-simultaneous, in practice the disclosed system sequences EMAT sampling and TFI sampling within a shared sampling window. Sequencing the measurement processes over a short time scale avoids electromagnetic interference, magnetic hysteresis effects, and acoustic ringing that could otherwise degrade signal quality if both modalities were actively sampled at the same instant. Because the sampling window is short relative to the distance traveled by the pipeline inspection gauge (PIG), the EMAT measurement sample and the TFI measurement sample correspond to substantially the same physical region of the pipeline wall. As a result, high-fidelity spatial correlation between sensing modalities is achieved without requiring true simultaneous excitation or sensing, which would impose unnecessary design constraints.

The use of a common sampling window for EMAT and TFI measurements enables precise alignment of measurement data with physical pipeline locations. By collecting EMAT and TFI samples within a same temporal window and associating those samples with position information derived from odometers, inertial sensors, and/or angular orientation sensors, the disclosed system ensures that both datasets are spatially co-registered. This approach reduces uncertainty in defect localization and allows downstream data processing to correlate ultrasonic reflections and magnetic leakage signatures to the same axial and circumferential positions along the pipeline. Such correlation is particularly important for identifying complex defect morphologies, including crack-like features in regions of metal loss or stress concentration.

In some embodiments, the disclosed system employs distance-based sampling rather than time-based sampling to account for variations in PIG velocity during pipeline traversal. Pipeline geometry, curvature, and/or flow conditions can cause the PIG to accelerate or decelerate, resulting in uneven spatial sampling if measurements are collected solely based on time. Distance-based sampling uses odometer data to trigger EMAT and TFI measurements at fixed spatial intervals, ensuring consistent spatial resolution along the pipeline regardless of tool speed. In certain embodiments, EMAT measurements and TFI measurements may be collected at different specified distances, reflecting differences in the spatial sensitivity and resolution characteristics of ultrasonic and magnetic sensing modalities.

The EMAT and TFI sensing modalities described herein provide complementary information about pipeline conditions. EMAT measurements are well suited for detecting crack-like features and for providing precise local wall thickness information, while TFI measurements provide wide-area, high-resolution mapping of magnetic anomalies associated with metal loss, deformation, or material discontinuities. In the disclosed system, EMAT measurement information and TFI measurement information are correlated based on shared spatial references to derive composite inspection data. In some embodiments, EMAT-derived thickness or crack depth information is used to constrain or normalize TFI signal amplitudes, reducing ambiguity in metal loss sizing and improving discrimination between critical defects and non-critical features.

By correlating EMAT and TFI measurement information, the disclosed system improves defect characterization beyond what is achievable with either modality alone. For example, EMAT measurements may identify axial cracks or stress corrosion cracking with high sensitivity, while TFI measurements identify surrounding metal loss or deformation that may influence defect criticality. The combined dataset enables accurate differentiation between crack-like features, corrosion-related metal loss, and benign geometric anomalies. This integrated approach reduces false calls and improves confidence in defect classification, sizing, and prioritization for remediation.

To achieve complete circumferential coverage of the pipeline wall, measurement surfaces and measurement sections are staggered angularly relative to a common cylindrical axis. Angular offsets between adjacent measurement surfaces and between adjacent measurement sections are selected to balance circumferential coverage with redundancy, ensuring that no region of the pipeline wall remains uninspected while avoiding excessive overlap of sensing areas. This arrangement allows EMAT and TFI measurements to interrogate the entire internal surface of the pipeline during a single traversal, even when individual measurement surfaces cover only a portion of the circumference.

The disclosed system supports both on-tool data acquisition and external data processing to provide flexibility in deployment and analysis. Raw or partially processed EMAT and TFI measurement samples may be stored in onboard memory during a pipeline run and subsequently transferred to an external data processing system for advanced analysis, data fusion, and reporting. Alternatively, certain preprocessing steps may be performed onboard the PIG to reduce data volume or to provide preliminary quality checks. This flexible architecture allows the system to scale across different pipeline lengths, inspection resolutions, and operational constraints.

A pipeline inspection method and system using a simultaneous or near-simultaneous combination of an EMAT measurement process and a TFI measurement process are accordingly disclosed herein. The method and system use a pipeline inspection gauge (PIG), equipped with various EMAT sensors and TFI sensors, to identify pipeline features or defects as the PIG traverses, is pushed through, or is otherwise propelled through a pipeline. The PIG may also include an odometer or other mechanism of measuring a distance travelled through a pipeline.

As used herein, ‘near-simultaneous’ refers to EMAT and TFI sampling operations occurring within a common sampling window that is short relative to a distance traveled by the PIG, such that both measurements correspond to substantially the same physical region of the pipeline wall.

The pipeline inspection method and system disclosed herein may also include a memory device capable of storing various measurement data during a pipeline inspection. Measurement data may include EMAT measurement samples, TFI measurement samples, or odometer information.

The PIG may include various PIG measurement sections. A number of PIG measurement sections may be two, three, four, or more in many embodiments of the disclosure. A PIG measurement section may be a standalone measurement device, capable of performing an EMAT measurement process and a TFI measurement process that is independent of other measurement processes performed by other PIG measurement sections. Alternatively, an EMAT measurement process and a TFI measurement process may comprise component measurement processes that are combined among or coordinated from various PIG measurement sections. In some embodiments, one or more PIG measurement sections may include a speed control unit (SCU) for high flow rates. Additionally or alternatively, one or more PIG measurement sections may include additional batteries to provide power for extended durations.

### Example Pipeline Inspection System

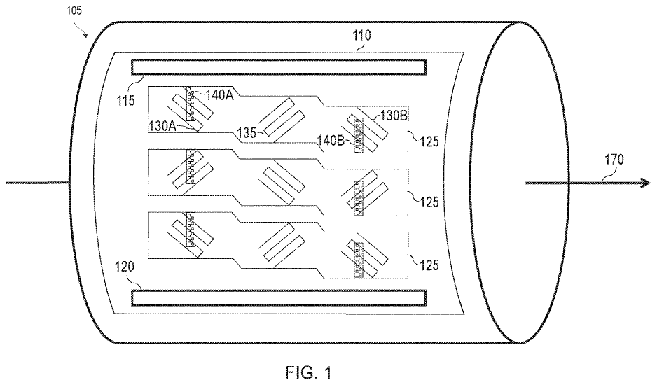

FIG. 1 is a diagram of a pipeline inspection gauge (PIG) section 105, a component of a pipeline inspection system, according to an example embodiment of the present disclosure. The PIG measurement section includes at least one measurement surface 110. In some embodiments, a PIG measurement section may include four measurement surfaces, in other embodiments a PIG measurement section may include other even-number measurements. A PIG measurement section may be substantially cylindrical or any shape that is able to traverse a pipeline such that various measurement surfaces are in close proximity to an interior surface of a pipeline wall. A cylindrical axis 170 through the PIG measurement section corresponds to a direction of travel of the PIG measurement section through a pipeline.

A PIG measurement section also includes a magnetizer, having a first pole 115 and a second pole 120, at least one measurement flap 125. A measurement flap 125 includes various sensors and measurement components that implement both an electromagnetic acoustic transduction (EMAT) measurement process and a transverse field inspection (TFI) or magnetic flux leakage (MFL) measurement process. As used herein, TFI refers to a magnetic flux leakage measurement approach that emphasizes transverse and radial components of the leakage field, which may differ from conventional axial-component MFL systems.

An EMAT measurement process may be based on guided, shear horizontal (SH) acoustic waves, including SH0, SH1, and other modes, that travel through a pipeline wall and are reflected by various pipeline features, including crack-like features, crack colonies, scratches or scores in a pipeline, notch-like cracks or defects, weld anomalies, or other pipeline features or defects. In some embodiments, the magnetizer is configured to generate a static magnetic field having a flux density sufficient to support Lorentz-force-based EMAT operation while remaining within a range that enables high-resolution transverse magnetic flux leakage measurements, thereby allowing both sensing modalities to operate using a common magnetization source. Although shear horizontal wave modes such as SH0 and SH1 are described in example embodiments, other guided wave modes may be used without departing from the scope of the disclosure.

A measurement flap 125 includes a first EMAT receiver coil 130A, an EMAT transmitter coil 135, and a second EMAT receiver coil 130B. Furthermore, the measurement flap 125 includes a first array of Hall sensors 140A and a second array of Hall sensors 140B, each implementing a TFI measurement process. Unless otherwise noted, reference numeral 140 refers generally to an array of Hall sensors, while reference numerals 140A and 140B refer to specific instances thereof.

An array of Hall sensors may include about 12 Hall sensors, and each Hall sensor may be a tri-axial Hall sensor or a single-axis Hall sensor. The first array of Hall sensors may overlap with a receiver coil, and may be separated, in a radial direction relative to the cylindrical axis 170, by a distance of between about 2 to about 4 millimeters, as shown in the illustrated embodiment. However, it should be appreciated that other circumferential sensor spacings are possible.

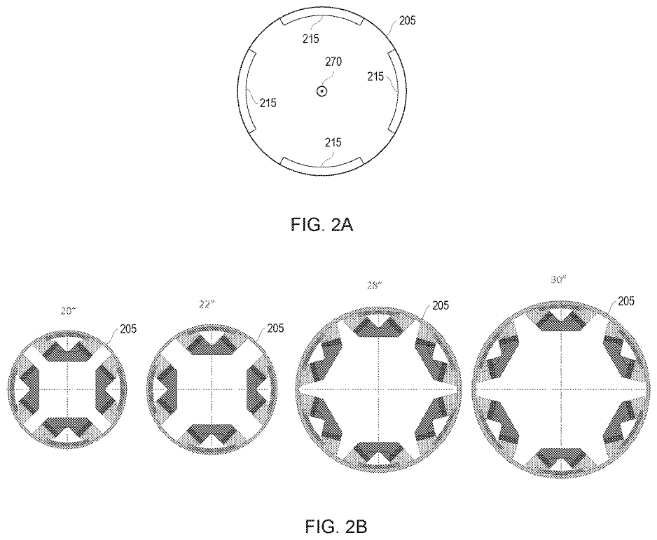

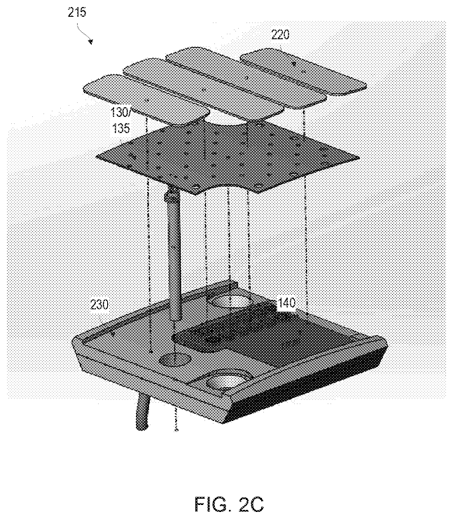

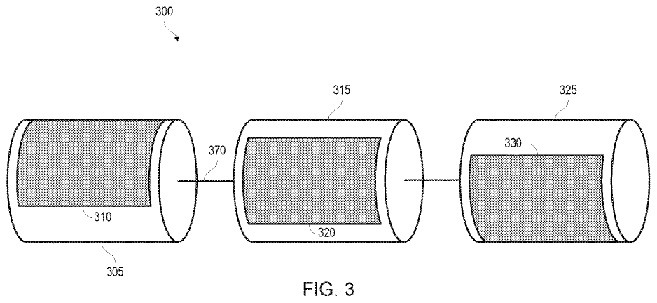

FIG. 2A is a cross-sectional diagram of an example pipeline inspection system including a PIG measurement section 205 and multiple measurement surfaces 215 (e.g., four measurement surfaces 110 of FIG. 1) distributed around a cylindrical axis 270. In this embodiment, each measurement surface 215 includes three measurement flaps 125. It should be appreciated that each measurement surface 215 may include four or five measurement flaps 125 for larger diameter PIG measurement sections 205. A circumference of the PIG section 105 has four evenly spaced-apart measurement surfaces 215. To provide complete coverage, three PIG measurement sections 205 are used. The coverage of each measurement surface 215 is approximately 30° of the pipeline circumference (e.g., 360°/(3 measurement sections each having 4 measurement surfaces). As shown in FIG. 3, each measurement section 205 (e.g., measurement sections 305, 315, 325) is rotated 30° from the adjacent sections. Various measurement surfaces may not cover an entire circumference of a PIG measurement section, but in most embodiments a system for inspecting a pipeline, as disclosed herein, includes two or more PIG measurement sections, such as in the embodiment of FIG. 3.

FIG. 2B shows cross-sectional diagrams of an example pipeline inspection system including a PIG measurement section 205 having multiple measurement surfaces 215 for pipes of different diameters. For a 20-inch pipe and a 22 inch-pipe, the PIG measurement section 205 includes four measurement surfaces 215. For a 28-inch pipe and a 30 inch-pipe, the PIG measurement section 205 includes six multiple measurement surfaces 215. The PIG measurement section 205 may include additional even-numbered multiple measurement surfaces for larger diameter pipes.

FIG. 2C shows an assembly-view of a measurement surface 215, according to an example embodiment of the present disclosure. The example measurement surface 215 includes wear protection pads 220, one or more EMAT receiver coils 130, one or more EMAT transmitter coils 135, and one or more arrays of Hall sensors 140. The wear protection pads 220 are configured to contact an interior surface of a pipeline and prevent the one or more EMAT receiver coils 130, one or more EMAT transmitter coils 135, and one or more arrays of Hall sensors 140 from becoming damaged from any pipeline protrusions or defects. The wear protection pads 220 may include flat or substantially flat, high wear-resistant, non-conductive strips, such as ceramic.

The one or more EMAT receiver coils 130 and the one or more EMAT transmitter coils 135 are located beneath the wear protection pads 220 and are configured to collect EMAT measurement data, as discussed herein. The one or more EMAT receiver coils 130 and the one or more EMAT transmitter coils 135 may be mounted to a fiberglass printed circuit board. As shown in FIG. 2C, the fiberglass printed circuit board is mounted to a housing 230 of the measurement surface 215.

The one or more arrays of Hall sensors 140 are located beneath the fiberglass printed circuit board and the one or more EMAT receiver coils 130 and the one or more EMAT transmitter coils 135. The one or more arrays of Hall sensors 140 are mounted to a printed circuit board, which is connected to the housing 230. The stacking of the one or more arrays of Hall sensors 140 and the one or more EMAT receiver coils 130 and the one or more EMAT transmitter coils 135 allows the pipeline inspection system to provide two sensing modalities for the same pipeline area. As such, two different PIG sections or two different PIGs for EMAT and TFI measurements are not needed, thereby conserving space or reducing the number of inspection runs.

FIG. 3 is a diagram of an example pipeline inspection system 300 including multiple PIG measurement sections. For example, a first PIG measurement section 305, a second PIG measurement section 315, and a third PIG measurement section 325 share a common cylindrical axis 370. Measurement surfaces on any PIG measurement section may be staggered in an angular or circumferential direction to achieve a full coverage of an interior surface of a pipeline. For example, in FIG. 3, a measurement surface 310 of the first PIG measurement section is rotated about the cylindrical axis relative to a measurement surface 320 of the second PIG measurement section, and a measurement surface 330 of the third PIG measurement section is rotated about the cylindrical axis 370 relative to the measurement surface 320 of the second PIG measurement section.

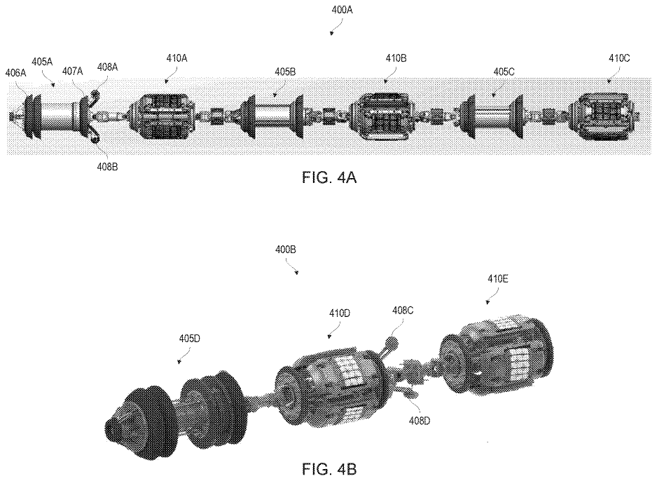

FIG. 4A is a diagram of a PIG tool 400A including multiple PIG measurement sections 410A-C and multiple instrument sections 405A-C. PIG measurement sections are placed between instrument sections. FIG. 4B shows an alternative embodiment of a PIG tool 400B comprising two adjacent PIG measurement sections 410D, 410E and a first instrument section 405D. An instrument section may include at least two spring-supported odometer arms 408A, 408B, where each odometer arm includes a wheel sensor that is configured to contact an inner surface of a pipeline to measure a distance traveled. In some embodiments, a PIG measurement section may include at least two odometer arms 408C, 408D. The odometer arms are spring-loaded to ensure contact is made with an interior of a pipeline throughout a run despite any curvature or anomalies in the pipeline. An instrument section may include cups 406A, 407A that are configured to have a diameter that is less than an inner diameter of the pipeline. Together, the cups provide support and alignment of a PIG tool during a traversal of a pipeline. The cups are configured to enable an instrument section to become at least partially pressurized within a pipeline. A fluid such as gas or a liquid may be pumped in the pipeline behind a PIG tool 400A, 400B. The cups prevent at least some of the fluid from flowing past, thereby creating pressure. The differential pressure is created mostly at a first or driving section with sealed cups. Other section caps have enough bypass slots/holes to avoid jack-knifing at the flexible U-joints. The created fluidic pressure is used to push a PIG tool through a pipeline.

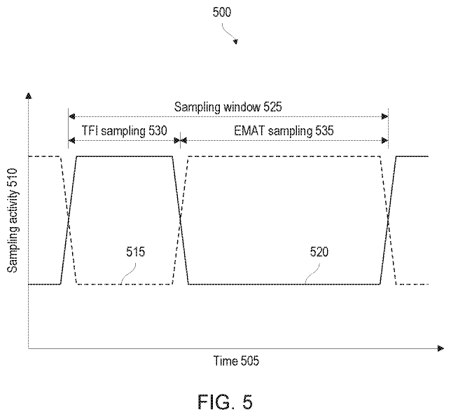

FIG. 5 is an example timing diagram 500 of a sequencing of a TFI sampling and an EMAT sampling of a PIG as it traverses a pipeline. While a PIG, a PIG measurement section, a measurement surface, or a measurement flap include shared measurement components, such as a shared magnetizer (collectively, the first pole 115, the second pole 120, and the at least one measurement flap 125 of FIG. 1) that creates a static magnetic field for EMAT and TFI measurement processes, and include measurement components that at least partially overlap, such as TFI Hall sensors and EMAT receiver coils, a shared data acquisition system sequences or interleaves a TFI sampling and an EMAT sampling over a small time scale such that a PIG completes a TFI measurement process and an EMAT measurement process in a single traversal of a pipeline. A staggering of multiple or redundant measurement components in circumferential, radial, and axial directions, as is illustrated in FIG. 1, FIG. 2, and FIG. 3, ensures that a PIG interrogates an entirety of an internal surface of a pipeline with each of a TFI measurement process and an EMAT measurement process, even though a TFI sampling and an EMAT sampling are sequenced in time. FIG. 5 shows a clock signal 515 of a data acquisition system or an amount of sampling activity 510 for an EMAT sampling and a clock signal 520 of a data acquisition system or an amount of sampling activity 510 for a TFI sampling versus time 505. Together, an EMAT sampling and a TFI sampling occur in a sampling window 525. In some embodiments, a minimum sampling window or a minimum sampling period is 1.5 ms. The sampling window 525 comprises a TFI sampling period 530 and an EMAT sampling period 535. In some embodiments, a TFI sampling period is one third of a minimum sampling period, or about 0.5 ms, and an EMAT sampling period is two thirds of a minimum sampling period, or about 1.0 ms.

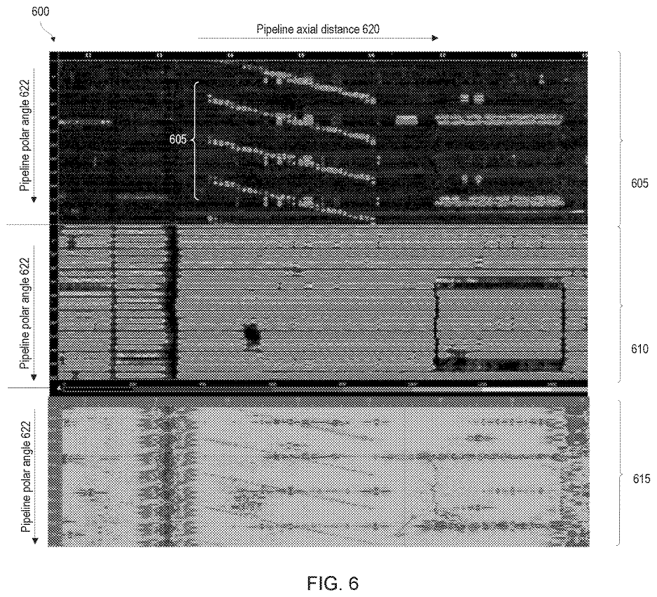

FIG. 6 is a plot 600 of a first collection of sensed data 605, a second collection of sensed data 610, and a third collection of sensed data 615 from a pipeline inspection by a PIG, as disclosed herein. The plot 600 shows a map of sensed data relative to a pipeline axial distance 620 and a pipeline polar angle 622. The first collection of sensed data 605, for example, shows helically-distributed features in a pipeline. The first and second collection of sensed data 605 and 610 may be, for example, a collection of EMAT measurement data (e.g., C-scans). The first collection of sensed data 605 includes reflected echoes and the second collection of sensed data 610 includes a through transmission signal. The third collection of sensed data 615 includes TFI measurement data. In general, the PIG, by means of TFI and EMAT measurement processes, is configured to detect various pipeline features including crack-like features or other defects.

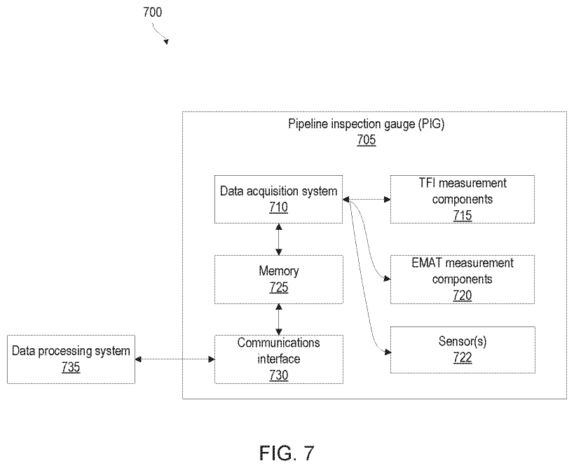

FIG. 7 is a diagram of a system 700 for inspecting pipelines, including a PIG 705 and external data processing system 735. The PIG 705 includes a data acquisition system 710 that is in communication with TFI measurement components 715 and EMAT measurement components 720. The TFI measurement components include Hall sensors and various control elements, and the EMAT measurement components include transmitter coils, receiver coils, and various control elements, both operating with a magnetizer. The data acquisition system 710 sequences or coordinates a TFI measurement process and an EMAT measurement process, and also collects or collates TFI measurement samples and EMAT measurement samples. In some embodiments, EMAT samples are collected at a first specified distance corresponding to an ultrasonic wavelength-dependent spatial resolution, while TFI samples are collected at a second specified distance corresponding to magnetic flux leakage spatial sensitivity.

The data acquisition system stores TFI or EMAT measurement samples in a memory 725. The PIG 705 includes a communications interface 730 which is in communication with the memory 725. The communications interface may be a USB interface, a network interface such as an Ethernet interface or Wi-Fi interface, or any electrical or wireless communications interface.

The system 700 includes an external data processing system 735 that is in communication with the communications interface 730. The external data processing system 735 is configured to download TFI measurement samples, EMAT measurement samples, or other measurement samples from the PIG via the communications interface 730. The data processing system 735 may be a computer, a user interface, a machine learning model, or any automated or user-controlled computational system.

In some embodiments, the PIG 705 includes one or more sensors 722, such as a distance measurement sensor (e.g., an odometer), an accelerometer, a three-axis accelerometer, an inertial measurement unit (IMU), a real-time clock, etc. Data from the sensor(s) 722 is used by the data acquisition system 710 and/or the data processing system 735 to align data from the TFI measurement components 715 with data from the EMAT measurement components 720. Data from the sensor(s) 722 is also used by the data acquisition system 710 and/or the data processing system 735 to align the TFI and EMAT data with corresponding physical locations and angular orientation within a pipeline. For instance, a distance measured by the odometer is used to determine a known location within the pipeline that is a fixed distance from a starting location. Additionally, a relative position/orientation measured by a three-axis accelerometer or IMU is used to align measurement data with actual bends or curvatures in a pipeline.

In an example, the data from the TFI measurement components 715 and the data from the EMAT measurement components 720 may be associated with corresponding distance data from the odometer and/or angular data from the three-axis accelerometer. The data processing system 735 is configured to use the odometer data to determine a corresponding location in a pipeline given a known starting location. Further, the data processing system 735 is configured to compare the data from the three-axis accelerometer to known bends and curvatures in the pipeline to confirm the location information is correct or adjust the location information. The data processing system 735 then associates the data from the TFI measurement components 715 and the data from the EMAT measurement components 720 with the physical pipeline location. Such an association allows a user to know exactly where detected defects and deformities are located within a pipeline, which can extend hundreds of miles.

In some embodiments, the odometer and/or clock may be used for sampling the EMAT and TFI data. As discussed above, a minimum sampling window or a minimum sampling period is 1.5 ms. The sampling window comprises a TFI sampling period and an EMAT sampling period. In some embodiments, a TFI sampling period is one third of a minimum sampling period, or about 0.5 ms, and an EMAT sampling period is two thirds of a minimum sampling period, or about 1.0 ms. It should be appreciated that the minimum sampling window or the minimum sampling period is greater than or less than 1.5 ms. For example, the minimum sampling window or the minimum sampling period may be between 0.1 ms and 20 ms.

As an alternative to time-based sampling, the data acquisition system 710 may be configured with distance-based sampling. The data acquisition system 710 uses the distance-based sampling to provide synchronization of the time windows independent of a speed of the PIG 705. For example, during an inspection, the PIG 705 may move more quickly in straight sections and more slowly in curved sections. For time-based sampling, this means having more samples in the curves and fewer samples in straight sections. For distance-based sampling, the data acquisition system 710 is configured to acquire TFI and EMAT data samples at fixed distances using distance data from the odometer. For example, the EMAT data may be collected at a first specified distance and the TFI data may be collected at a second specified distance. The specified distances may be between 0.1 millimeters and 10 millimeters.

In some embodiments, the data processing system 735 is configured to derive composite inspection data by correlating EMAT measurement information and TFI measurement information. The data processing system 735 may use spatial alignment and/or confidence weighting to correlate the EMAT measurement information and the TFI measurement information. In some embodiments, the data processing system 735 uses EMAT-derived wall thickness measurements to constrain or normalize TFI signal amplitudes, thereby reducing ambiguity in metal loss sizing.

This data fusion performed by the data processing system 735 merges EMAT's strengths in crack detection and precise thickness measurement with TFI's superior, high-resolution, 360-degree axial mapping, resulting in detailed 3D anomaly modeling and reduced false calls. In an example, this data fusion creates a continuous, high-resolution 3D map of defect geometries (e.g., subsurface corrosion profiles). This allows visualization of the exact depth and shape of metal loss, even in complex, clustered corrosion scenarios that are difficult to size with a single technology. Further, by combining EMAT's precise local wall thickness data with TFI's wide-area mapping, a complete volumetric representation of metal loss, surface irregularities, and material degradation can be produced.

The data fusion provided by the data processing system 735 also includes enhanced crack and defect characterization. For instance, combining EMAT's high sensitivity to axial cracks and stress corrosion cracking (SCC) with TFI's detection of metal loss allows for accurate discrimination between critical crack-like features and non-critical metal loss. EMAT can also be used to detect disbanded coating, which, when combined with TFI, allows for the correlation of surface abnormalities with potential under-film corrosion. Further, while TFI (or MFL) typically detects corrosion, integrating EMAT data provides the precise depth of SCC and axial fatigue cracks.

The creation of composite inspection data also includes pipeline integrity metrics. By utilizing the precise 3D anomaly map derived from both technologies, the data processing system 735 can be configured to calculate or estimate burst pressure with much higher confidence, approaching the accuracy of in-ditch laser scans. Additionally, data fusion allows for the elimination of false calls (e.g., identifying non-critical features that mimic cracks), resulting in the data processing system 735 providing for an optimized excavation and repair program.

The data processing system 735 may further use the composite inspection data for 360-degree defect assessment. Combining both datasets ensures 100% pipeline coverage with accurate, 360-degree detection of both internal and external anomalies, including those oriented along the length of the pipe. Moreover, the data processing system 735 may further use the composite inspection data for residual stress mapping. The data processing system 735 uses EMAT for measuring longitudinal and shear-wave velocities, enabling the derivation of residual stress profiles in pipelines. This, combined with TFI, aids in identifying areas with high stress levels. By fusing these datasets, the data processing system 735 is configured to effectively turn thousands of raw data points into actionable intelligence, reducing uncertainty in critical assessment of pipelines.

### Conclusion

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for inspecting pipelines, the system comprising:
a pipe inspection gauge (PIG), the PIG comprising:
at least one cylindrical PIG measurement section, each cylindrical PIG measurement section comprising:
a magnetizer providing a static magnetic field;
at least one measurement surface, each measurement surface comprising:
at least one EMAT sensor; and
at least one transverse field inspection (TFI) sensor;
wherein the static magnetic field interacts with the at least one EMAT sensor in an EMAT measurement process and wherein the static magnetic field acts
with the at least one TFI sensor in a TFI measurement process;
a memory device;
a processor communicatively coupled to the at least one EMAT sensor, the at least one TFI sensor, and the memory device configured to:
store EMAT measurement information and store TFI measurement information;
collect an EMAT measurement sample in sequence with a TFI measurement sample; and
collect position information of the PIG along a pipeline;
wherein the system is operable to inspect a length of a pipeline with an EMAT measurement process and with a TFI measurement process in a single traversal of the PIG along the length of the pipeline, and wherein the system is operable to identify one or more pipeline features based on the EMAT measurement process and the TFI measurement process.

2. The system of claim 1, further comprising a computer operable to:
receive EMAT measurement information and TFI measurement information from the processor of the PIG;
combine an EMAT measurement sample collected in sequence with a TFI measurement sample;
combine position information with EMAT measurement information and TFI measurement information; and
process the length of the pipeline to identify pipeline features, assign a feature class to each pipeline feature, and determine an axial position, an angular position, linear dimensions, and a size for each pipeline feature.

3. The system of claim 2, wherein the computer is communicatively coupled to the processor via at least one of a wired or wireless connection.

4. The system of claim 2, wherein the processing includes correlating the EMAT measurement information and TFI measurement information to derive composite inspection data.

5. The system of claim 2, wherein the computer is configured to generate an electronic report that includes the identified pipeline features specifying the feature class, the axial position, the angular position, the linear dimensions, and the size for each pipeline feature, and wherein the computer is configured to transmit the electronic report to a client device for display.

6. The system of claim 1, wherein each of the at least one measurement surface comprises at least one measurement flap, wherein the at least one measurement flap comprises:
an EMAT transmitter coil;
an EMAT receiver coil;
an array of Hall sensors that overlaps partially with the EMAT receiver coil.

7. The system of claim 6, further comprising a cylindrical axis of the at least one cylindrical PIG measurement section, wherein the EMAT transmitter coil is separated by an angle, relative to the cylindrical axis, of between 1 and 30 degrees from the EMAT receiver coil.

8. The system of claim 6 wherein the array of Hall sensors comprises twelve tri-axial Hall sensors.

9. The system of claim 6 wherein the array of Hall sensors comprises a plurality of single-axis Hall sensors.

10. The system of claim 6, wherein the array of Hall sensors is separated by a distance of about 4 millimeters or less from the EMAT receiver coil.

11. The system of claim 2, further comprising a first cylindrical PIG measurement section, a second cylindrical PIG measurement section, and a third cylindrical PIG measurement section, wherein the first, the second, and the third cylindrical PIG measurement sections share a common cylindrical axis, and wherein a measurement surface of the first cylindrical PIG measurement section is separated by an angle, relative to the common cylindrical axis, of between 1 and 30 degrees from a measurement surface of the second cylindrical PIG measurement section, and wherein a measurement surface of the second cylindrical PIG measurement section is separated by an angle, relative to the common cylindrical axis, of between 1 and 30 degrees from a measurement surface of the third cylindrical PIG measurement section.

12. The system of claim 2, wherein the feature class includes at least one of a deposit, a buckle, a dent, a presence of an ovality, a wall thickness change, a presence of a through-hole, a presence of a stress/strain zone, a presence of a weld, and/or a hard spot, a crack, a fatigue crack, or a metal loss.

13. The system of claim 2, wherein the computer is configured to create an electronic report that includes the identified pipeline features specifying the assigned feature class, the axial position, the angular position, the linear dimensions, and the size.

14. The system of claim 1, wherein the system is configured to collect the EMAT measurement sample within about 1.5 milliseconds or less and wherein the system configured to collect the TFI measurement sample within about 1.5 milliseconds or less.

15. The system of claim 1, wherein the system is configured to collect the EMAT measurement sample over a first specified distance and wherein the system configured to collect the TFI measurement sample over a second specified distance.

16. The system of claim 1, wherein an ultrasonic wave frequency in the EMAT measurement process is between about 200 kHz to about 800 kHz.

17. The system of claim 1, wherein a pipeline diameter is between about 14 inches to about 56 inches.

18. The system of claim 1, further comprising a cylindrical axis of the at least one cylindrical PIG measurement section, wherein the TFI measurement sample corresponds to three components of magnetic leakage field measured in an axial direction relative to the cylindrical axis, in a circumferential direction relative to the cylindrical axis, and in a radial direction relative to the cylindrical axis.

19. The system of claim 1, further comprising at least one odometer, wherein the processor is operable to store odometer data, and wherein the odometer data is combined with the EMAT measurement process and the TFI measurement process.

20. The system of claim 1, further comprising at least one angular orientation sensor, wherein the processor is operable to store angular orientation data, and wherein the angular orientation data is combined with the EMAT measurement process and the TFI measurement process.

21. A method for inspecting pipelines, the method comprising:
traversing a pipeline once with a pipeline inspection gauge (PIG);
applying a static magnetic field through a wall of a pipeline with a magnetizer common for collecting EMAT measurement samples and TFI measurement samples;
collecting, during the traversing, plurality of EMAT measurement samples within a first time duration; and
collecting, during the traversing, a plurality of TFI measurement samples within a second time duration.

22. The method of claim 21, further comprising:
generating EMAT measurement data from the plurality of EMAT measurement samples;
generating TFI measurement data from the plurality of TFI measurement samples; and
combining EMAT measurement data and TFI measurement data to create a physical condition map of a pipeline wall representing wall thickness variations or magnetic leakage characteristics.

23. The method of claim 22, further comprising identifying, in a data processing environment, cracks in a pipeline wall based on physical anomalies detected in the EMAT measurement data and the TFI measurement data.
